(19) United States
(12) Patent Application Publication
(10) Pub. No.: US 2010/0067694 A1
(43) Pub. Date: Mar. 18, 2010

(54) FILE-TRANSMITTING METHOD AND SCANNING DEVICE USING THE SAME

(75) Inventor: Charlie Chou, Hsinchu City (TW)

Correspondence Address: COVENANT IP CONSULTING CO., P.O. BOX 34-306 TAIPEI CITY, TAIPEI, 10499, TW

(73) Assignee: AVISION INC., Hsinchu (TW)

(21) Appl. No.: 12/505,486

(22) Filed: Jul. 19, 2009

(30) Foreign Application Priority Data
Sep. 16, 2008 (TW) 97135476

(51) Int. Cl. G06F 15/00; H04N 1/44; H04L 9/32; G06F 17/30; H04L 9/00

(52) U.S. Cl. 380/243; 358/1.15; 726/18; 707/E17.032

(57) ABSTRACT

A file-transmitting method and a scanning device are provided. A document is scanned and an image file of the document is generated. The image file is stored to a remote storage device. File-access data for accessing the image file is generated. The file-access data is transmitted to a receiving destination. The scanning device includes a scanning head assembly, a processing unit and a transmitting unit. The scanning head assembly scans a document and generates an image file of the document. The processing unit, electrically coupled to the scanning head assembly, processes the image file and generates file-access data for accessing the image file. The transmitting unit, electrically coupled to the processing unit, transmits and stores the image file to a remote storage device, and transmits the file-access data to a receiving destination.

This application claims the benefit of Taiwan application Serial No. 97135476, filed Sep. 16, 2008, the subject matter of which is incorporated herein by reference.

### BACKGROUND OF THE INVENTION

1. Field of the Invention

The invention relates generally to transmitting files from a scanning device, and more particularly to methods and scanning devices for storing an image file to a remote storage device and transmitting file-access data to a specific recipient.

2. Description of the Related Art

A typical document scanner captures image of photos or documents and electronically stores the digital files of the image to a computer. When a scanner incorporates the function of network scanning and is connected to a network, the digital files can be stored to a remote storage device connected to the network for filing the images, or sent to a designated e-mail address via the Internet.

However, the digital files of the images sent to each individual recipient occupy a lot of space of mail servers and consume a great amount of network resources. In addition, any user authorized to access the remote storage device can open, browse and edit all digital files of the images stored in the remote storage device. Such practice may ultimately jeopardize the security of image files stored in the remote storage device.

### SUMMARY OF THE INVENTION

The invention is directed to a file-transmitting method and a scanning device using such method. The scanning device scans a document, stores an image file of the document to a remote storage device, and transmits file-access data for accessing the image file to at least a receiving destination. Such image file stored in the remote storage device is accessible only by the authorized users who receive the file-access data. Data security is hence increased.

In one embodiment of the present invention, a file-transmitting method for transmitting an image file and file-accessing data is described. Firstly, a document is scanned and an image file of the document is generated. Next, the image file is stored to a remote storage device. Then, file-access data for accessing the image file is generated. Then, the file-access data is transmitted to a receiving destination.

In another embodiment of the present invention, a scanning device including a scanning head assembly, a processing unit and a transmitting unit is provided. The scanning head assembly scans a document and generates an image file of the document. The processing unit, electrically coupled to the scanning head assembly, processes the image file and generates file-access data for accessing the image file. The transmitting unit, electrically coupled to the processing unit, transmits and stores the image file to a remote storage device, and transmits the file-access data to a receiving destination.

The invention will become apparent from the following detailed description of the preferred but non-limiting embodiments. The following description is made with reference to the accompanying drawings.

### BRIEF DESCRIPTION OF THE DRAWINGS

FIG. 1 shows a flow chart of a file-transmitting method according to an embodiment of the invention;

FIG. 2 shows a functional block diagram of a scanning device according to another embodiment of the invention; and

FIG. 3 shows a functional block diagram of the scanning device of FIG. 2 transmitting file-access data to a designated facsimile number via a telecommunication network according to another embodiment of the invention.

### DETAILED DESCRIPTION OF THE INVENTION

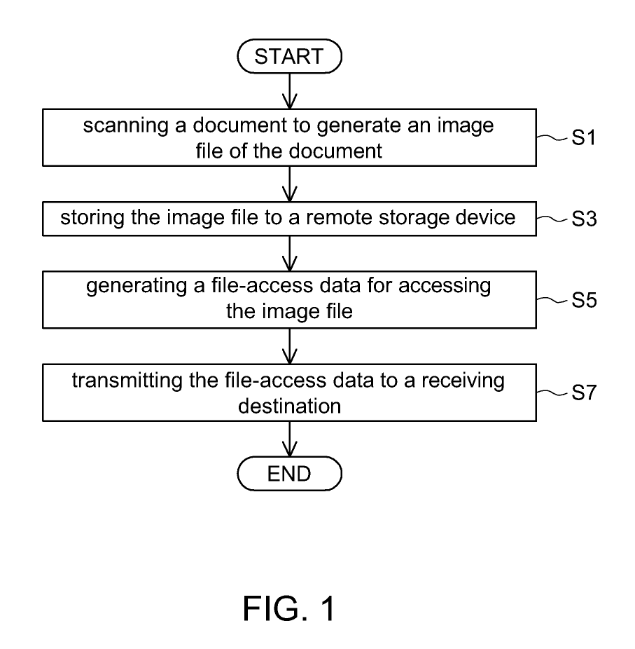

The file-transmitting method according to an embodiment of the invention is disclosed. Referring to FIG. 1, a flow chart of the file-transmitting method according to an embodiment of the invention is shown. At step S1, a document is scanned and an image file of the scanned document is generated accordingly. After the image file is generated, the method proceeds to step S3.

In step S3, the image file is stored to a remote storage device. For example, the remote storage device can be a file server or a personal computer (PC). Prior to step S3, the image file may be encrypted first. The encrypted image file is stored to the remote storage device, so that the security of data transmission is enhanced. In this case, a set of bits in the encrypted image file may be captured as a file password for accessing the encrypted image file. In step S3, the image file is transmitted to the remote storage device via a network and the network may be a local area network (LAN) or the Internet.

Next, in step S5, file-access data for accessing the image file is generated. The file-access data may be a filing address, a file password or a username for accessing the image file stored in the remote storage device. The filing address indicates where the image file is stored, and the file password and the username may be created by a user or created automatically for accessing the image file. Further, as mentioned above, prior to step S3, the image file can further be encrypted, and a set of bits in the encrypted image file is extracted and used as a file password. In this case, the file-access data can further include the file password derived from the encrypted image file. When a user wishes to access the image file at a location indicated by the filing address, the user has to input the file password and/or username for accessing the image file. The above example is one of the embodiments of the invention, and the scope of the invention is not limited thereto.

Next, the file-access data is transmitted. In step S7, the file-access data is transmitted to at least one receiving destination, such as an e-mail address or a facsimile number. Further, step S7 includes a step of receiving an entry of an e-mail address or a facsimile number, and mailing electronically the file-access data to the e-mail address or tele-faxing the file-access data to the facsimile number, so that the file-access data is received by at least one user who is granted to access the image file. In step S7, the file-access data can be transmitted via the same network used for transmitting the image file in step S3, or via a different network. Specifically, the network for transmitting the file-access data can be a local area network or the Internet when the receiving destination is an e-mail address, or the network can be a telecommunication network when the receiving destination is a facsimile number.

According to the file-transmitting method of the embodiment of the invention, the image file of the scanned document is stored to the remote storage device via a network; and the file-access data for accessing the image file is generated accordingly. The file-access data may include the file password of the image file, the filing address of the image file stored in the remote storage device, the username with access authority, and so on. By transmitting the file-access data to one or more designated receiving destinations (such as an e-mail address or a facsimile number), it is assured that only those users receiving the file-access data are able to obtain the data such as the address and the password of the image file. Since only the authorized person can obtain the file-access data and thereby access the image file, the security of the image file of the scanned document is increased.

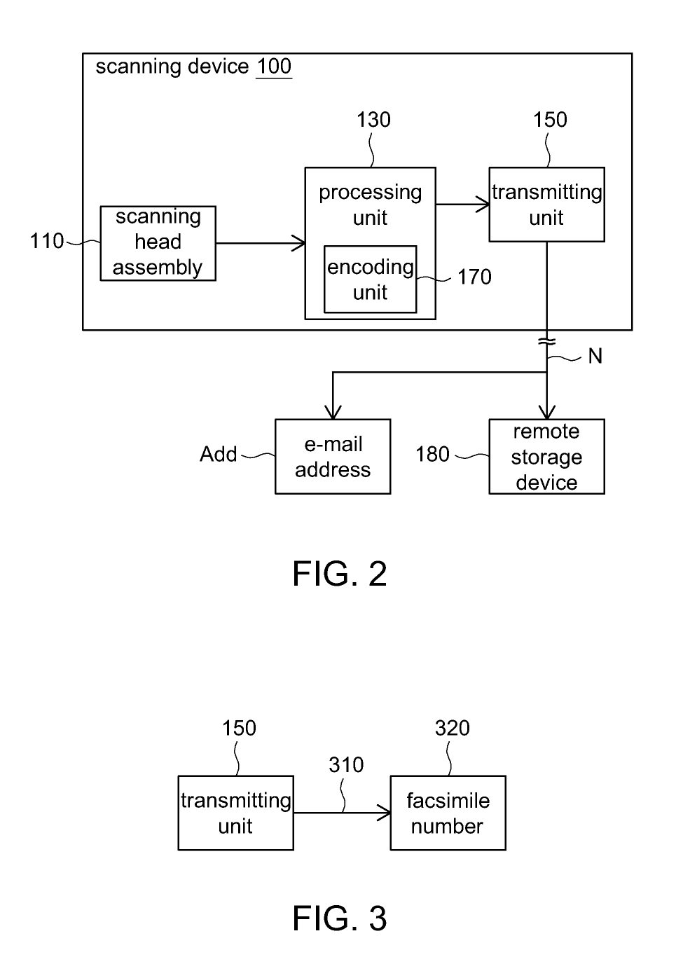

Referring to FIG. 2, a functional block diagram of a scanning device according to another embodiment of the invention is shown. The scanning device 100 includes a scanning head assembly 110, a processing unit 130 and a transmitting unit 150.

The scanning head assembly 110 scans a document and generates an image file of the document. The processing unit 130 is electrically coupled to the scanning head assembly 110. The processing unit 130 processes the image file generated by the scanning head assembly 110 and generates file-access data for accessing the image file. The transmitting unit 150 is electrically coupled to the processing unit 130. The transmitting unit 150 transmits and stores the image file to a remote storage device 180, such as a file server or a personal computer. Further, the transmitting unit 150 transmits the file-access data generated by the processing unit 130 to at least one receiving destination, such as an e-mail address Add. The file-access data comprises a filing address of the image file stored in the remote storage device 180 so the user can gain access to the protected image file using the file-access data.

Furthermore, the processing unit 130 of the scanning device 100 may include an encoding unit 170 which encrypts the image file, and the transmitting unit 150 transmits the encrypted image file to the remote storage device 180. With the encryption, the risk of data leakage is minimized during the transmission of the image file. The processing unit 130 uses a set of bits in the encrypted image file as a file password for the access of the encrypted image file. Thus, the file-access data may include the file password derived from the encrypted image file and the filing address of the image file. Alternatively or concurrently, the user may create a file password or a username by inputs via the user interface of the scanning device 100, and the processing unit 130 further processes the file password or username so that the file-access data can comprise the file password or username for accessing the image file.

The transmitting unit 150 transmits the image file to the remote storage device 180 via a network N, and the file-access data is transmitted to at least one receiving destination, such as the e-mail address Add, via the same network N or a different network. The network N can be a local area network or the Internet.

The transmitting unit 150 transmits the image file to the remote storage device 180 via the network N, and the file-access data for accessing the image file is transmitted to at least one receiving destination, such as the e-mail address Add, via the network N. Thus, only those persons receiving the file-access data have the access to the image file. The security of the image file of the scanned document is increased significantly.

However, the invention is not limited to the above exemplification. Transmission of the file-access data is not limited to transmission via a network. As indicated in FIG. 3, the transmitting unit 150 may also transmit the file-access data to a designated facsimile number 320 via a telecommunication network 310.

Besides, if the remote storage device 180 is a personal computer (PC), a recipient of the file-access data can access the image file stored in the remote storage device 180 through a peer to peer protocol, such as file transfer protocol (FTP). Also, a user may assign one of a plurality of PCs as the remote storage device 180. Or, one of the PCs may be originally set as a default remote storage device.

Since the image file is not sent as an attachment to an e-mail, size of the e-mail is reduced, and errors during transmission can be avoided.

Moreover, the scanning device according to the above embodiments of the present invention stores the image file to the remote storage device once instead of repeatedly transmitting the image file to each individual recipient, hence reducing the workload of the network and mail servers.

While the invention has been described by way of example and in terms of embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A file-transmitting method, comprising:
scanning a document to generate an image file of the document;
storing the image file to a remote storage device;
generating file-access data for accessing the image file; and
transmitting the file-access data to a receiving destination.

2. The method according to claim 1, wherein the step of generating the file-access data for accessing the image file comprises a step of:
generating a filing address of the image file stored in the remote storage device for accessing the image file.

3. The method according to claim 1, further comprising:
encrypting the image file.

4. The method according to claim 3, further comprising, after the step of encrypting the image file, a step of:
generating a file password according to the encrypted image file for accessing the image file.

5. The method according to claim 1, wherein the step of generating the file-access data for accessing the image file comprises a step of:
generating a file password created by a user for accessing the image file.

6. The method according to claim 1, wherein the step of generating the file-access data for accessing the image file comprises a step of:
generating a username created by a user for accessing the image file.

7. The method according to claim 1, wherein the step of storing the image file to the remote storage device comprises:
storing the image file to the remote storage device via a network, wherein the network is a local area network or the Internet.

8. The method according to claim 1, wherein the step of transmitting the file-access data to the receiving destination comprises:
transmitting the file-access data to an e-mail address via a network.

9. The method according to claim 1, wherein the step of transmitting the file-access data to the receiving destination comprises:
transmitting the file-access data to a facsimile number via a telecommunication network.

10. A scanning device, comprising:
a scanning head assembly, for scanning a document and generating an image file of the document;
a processing unit, electrically coupled to the scanning head assembly, for processing the image file and generating file-access data for accessing the image file; and
a transmitting unit, electrically coupled to the processing unit, for transmitting and storing the image file to a remote storage device, and transmitting the file-access data to a receiving destination.

11. The device according to claim 10, wherein the file-access data comprises a filing address of the image file stored in the remote storage device.

12. The device according to claim 10, wherein:
the processing unit comprises an encoding unit for encrypting the image file; and
the transmitting unit transmits the encrypted image file to the remote storage device.

13. The device according to claim 12, wherein the processing unit generates a file password according to the encrypted image file and the file password is for accessing the image file.

14. The device according to claim 10, wherein the file-access data comprises a file password created by a user for accessing the image file.

15. The device according to claim 10, wherein the file-access data comprises a username created by a user for accessing the image file.

16. The device according to claim 10, wherein the remote storage device is a file server.

17. The device according to claim 10, wherein the remote storage device is a personal computer.

18. The device according to claim 10, wherein the transmitting unit transmits the image file to the remote storage device via a network.

19. The device according to claim 10, wherein the transmitting unit transmits the file-access data to the receiving destination via a local area network or the Internet, wherein the receiving destination is an e-mail address.

20. The device according to claim 10, wherein the transmitting unit transmits the file-access data to the receiving destination via a telecommunication network, wherein the receiving destination is a facsimile number.
